(19) United States
(12) Patent Application Publication
(10) Pub. No.: US 2026/0226782 A1
(43) Pub. Date: Aug. 6, 2026

(54) AUTOMATIC DOOR OPENING AND CLOSING ACTUATOR

(71) Applicant: CHONGQING HI-LEX CABLE SYSTEM GROUP CO., LTD, Chongqing (CN)

(72) Inventors: Ping Zhang, Chongqing (CN); Jun Li, Chongqing (CN); Fangjun Chen, Chongqing (CN); Pengzhan Jin, Chongqing (CN); Kichu Mori, Chongqing (CN); Tiantai Liang, Chongqing (CN); Laiyun Liu, Chongqing (CN)

(21) Appl. No.: 19/635,716

(22) Filed: Mar. 31, 2026

Related U.S. Application Data
(63) Continuation-in-part of application No. PCT/CN2025/101768, filed on Jun. 18, 2025.

(30) Foreign Application Priority Data
Jun. 21, 2024 (CN) 202410807232.1
Jun. 21, 2024 (CN) 202421427922.6
Jun. 21, 2024 (CN) 202421437198.5

(51) Int. Cl. E05F 15/63; E05F 15/622

(52) U.S. Cl. CPC E05F 15/63; E05F 15/622; E05Y 2201/10; E05Y 2900/531

(57) ABSTRACT

The present disclosure provides an automatic door opening and closing actuator, belonging to the technical field of automobile components. The actuator includes a mounting housing and a push rod, wherein one end of the push rod extends out of a channel arranged on the mounting housing, and the other end of the push rod is arranged in the mounting housing to slide reciprocally, and further includes a sealing tube, wherein the sealing tube is sleeved outside the push rod, one end of the sealing tube is provided with an elastic covering ring wrapping the push rod, and the other end of the sealing tube is sealed and fixed to an inner wall of the channel or an end portion of the channel.

### CROSS-REFERENCE TO RELATED APPLICATION

The present disclosure is a Continuation-in-part Application of PCT Application No. PCT/CN2025/101768 filed on Jun. 18, 2025, which claims priority to Chinese Patent Application No. 202410807232.1, entitled “AUTOMATIC DOOR OPENING AND CLOSING ACTUATOR” filed with the China National Intellectual Property Administration on Jun. 21, 2024, Chinese Patent Application No. 202421427922.6, entitled “SLIDING PAIR STRUCTURE OF AUTOMATIC DOOR OPENING AND CLOSING ACTUATOR” filed with the China National Intellectual Property Administration on Jun. 21, 2024, and Chinese Patent Application No. 202421437198.5, entitled “SEALING STRUCTURE FOR PUSH ROD AND AUTOMATIC DOOR OPENING AND CLOSING ACTUATOR” filed with the China National Intellectual Property Administration on Jun. 21, 2024, the entire contents of which are incorporated herein by reference.

### TECHNICAL FIELD

The present disclosure relates to the technical field of auto parts, and in particular, to an automatic door opening and closing actuator.

### BACKGROUND ART

With the popularization of new energy vehicles, electric vehicles have already occupied a significant share in the automotive market. Their low noise, environmental friendliness, and various high-tech configuration functions are the selling points that attract users. The high-tech function of automatic door opening and closing brings unparalleled practicality.

The existing electric opening system for automobile doors, also known as the automotive electric door, is generally referred to as the electric door for short, which enables the electric opening of the automobile door through a combination of a door opening actuator, an electric suction door lock, a radar, an ECU and other parts installed on the automobile door, thereby allowing the door to be opened and closed without manual pushing or pulling. The actuator is the core component for realizing automatic door opening and closing, and can be divided into two structures: internal swing-type (without motion envelope) and external swing-type (with motion envelope).

The external swing-type actuator usually consists of a motor, a lead screw, a gearbox, and a bracket fixed to the door, and relies on the drive motor to drive the lead screw of the lead screw assembly to rotate, which then drives the gearbox on the lead screw to move axially. At the same time, the gearbox swings around the bracket to form an external envelope, thereby realizing the electric opening and closing of the automobile door. However, due to the external envelope of the above solution, it is necessary to set a large gap with other moving components in the door system, such as door and window glass, and glass regulator, etc. This leads to defects such as large installation space, complex layout, and low applicability. The internal swing-type actuator adopts an integrated structure, which utilizes a curved and telescopic push rod to contain the motion envelope inside the actuator, thereby pushing the door to realize its opening and closing.

The structure of the internal swing-type actuator in the prior art is, for example, similar to the structure disclosed in the patent application with the number CN202310518408.7, titled “ACTUATOR DEVICE FOR AUTOMOBILE SIDE DOOR OPENING”. This actuator includes a housing assembly, and a drive motor, a lead screw 5, a worm wheel 61, a threaded rod, a sliding guide device, and a drive connecting rod arranged inside the housing assembly. The threaded rod is rotatably connected within the housing assembly, and the drive motor, the lead screw 5, and the worm wheel 61 cooperate with each other to drive the threaded rod to rotate reciprocally. The sliding guide device is threadedly connected to the threaded rod. One end of the drive connecting rod is hinged to the sliding guide device, and the other end of the drive connecting rod extends out of the housing assembly and is hinged to an automotive body. During use, the rotation of the threaded rod drives the drive connecting rod to move and push the automotive body, making the door rotate along a hinge point between the door and the automotive body, thereby achieving the purpose of opening and closing the door.

In the above patent, compared with the external swing-type actuator, the internal swing-type actuator occupies less space in the door system, has a relatively easier system layout, and has stronger applicability. However, since the internal swing-type actuator has no motion envelope, it cannot achieve a waterproof effect. Even though a dustproof device (dustproof brush) in this patent can block part of the dust, the dustproof device still cannot achieve a waterproof purpose of the actuator. For this purpose, it is necessary to provide an internal swing-type actuator with a waterproof function.

### SUMMARY

The present disclosure adopts the following technical solution. An automatic door opening and closing actuator includes a mounting housing and a push rod, wherein one end of the push rod extends out of a channel arranged in the mounting housing, and the other end of the push rod is arranged to slide reciprocally inside the mounting housing. The automatic door opening and closing actuator further comprises a sealing tube sleeved outside the push rod. One end of the sealing tube is provided with a wrapping ring of an elastic material that wraps the push rod, and the other end of the sealing tube is hermetically fixed to an inner wall or one end of the channel.

An inner wall of the wrapping ring is provided with a circumferentially arranged first protruding ring. Two sides of the first protruding ring on the inner wall of the wrapping ring are each provided with at least one second protruding ring arranged at intervals. An oil groove for storing lubricating grease is formed between any adjacent first protruding ring and second protruding ring or between any two adjacent second protruding rings.

Both the first protruding ring and the second protruding rings are in interference fit with the push rod, and an annular center line of the first protruding ring is collinear with a center line of the push rod at a contact position between the first protruding ring and the push rod.

### BRIEF DESCRIPTION OF DRAWINGS

FIG. 1 is an exploded structural schematic diagram of one structure in the present disclosure;

FIG. 2 is one sectional view of one structure in the present disclosure;

FIG. 3 is another sectional view of one structure in the present disclosure;

FIG. 4 is an internal structural schematic diagram of one structure in the present disclosure;

FIG. 5 is another sectional view of one structure in the present disclosure;

FIG. 6 is an enlarged view of part D in FIG. 5;

FIG. 7 is a partial schematic diagram of FIG. 2;

FIG. 8 is an exploded structural schematic diagram of some components of an actuator of one structure in the present disclosure;

FIG. 9 is an appearance schematic diagram of a sealing tube in the present disclosure;

FIG. 10 is an envelope outline diagram of a push rod movement in the present disclosure;

FIG. 11 is a movement plan view of a push rod at different positions of a mounting housing during the use of an actuator in the present disclosure;

FIG. 12 is an exploded schematic diagram showing the fitting and installation of a sliding pair structure and a mounting housing of one structure in the present disclosure;

FIG. 13 is a sectional view along an axial direction of a lead screw when a sliding pair structure and a mounting housing of one structure are assembled in the present disclosure;

FIG. 14 is a sectional view along a radial direction of the lead screw when a sliding pair structure and a mounting housing of one structure are assembled in the present disclosure;

FIG. 15 is a structural schematic diagram of FIG. 14 with a housing and a lead screw 5 removed;

FIG. 16 is a sectional view of a nut slider of one structure along a radial direction of a lead screw 5 in the present disclosure;

FIG. 17 is a sectional view of a nut slider of one structure along an axial direction of a lead screw 5 in the present disclosure;

FIG. 18 is a simplified coordinate diagram showing a movement trajectory of a push rod in the present disclosure;

FIG. 19 is an appearance structural schematic diagram of a push rod in the present disclosure;

FIG. 20 is an exploded structural schematic diagram of another structure in the present disclosure;

FIG. 21 is a partial structural diagram of one sectional view of another structure in the present disclosure;

FIG. 22 is an exploded structural schematic diagram showing a nut slider, a mounting housing, a push rod, and a lead screw 5 of another structure in the present disclosure;

FIG. 23 is a sectional view along a radial direction of a lead screw 5 when a sliding pair structure and a mounting housing of another structure are assembled in the present disclosure; and

FIG. 24 is another sectional view of another structure in the present disclosure.

In the figures: mounting housing 2, end cover 21, bolt hole 101, lead screw 5, first cylindrical section 501, external spline section 502, second cylindrical section 503, push rod 3, sliding joint 31, hinge part 32, pin screw 4, retaining ring 401, nut slider 1, metal framework 11, plastic layer 12, buffer nut 13, mounting recess 131, mounting groove 14, connecting hole 141, chamfered surface 15, arc-shaped recessed area 151, auxiliary slider 16, sliding groove 17, plastic nut 18, threaded through hole 181, gearbox housing 20, cover plate 201, annular snapping groove 202, reinforcing rib 203, supporting framework 310, connecting recess 311, annular plate 312, elastic layer 320, barrier block 323, wrapping ring 33, second protruding ring 331, first protruding ring 332, oil groove 333, sealing tube 34, mounting through hole 35, positioning plate 351, connecting through hole 36, second annular protrusion 37, first annular protrusion 38, servo motor 6, worm wheel 61, worm 62, output shaft 601, stop shaft sleeve 611, circlip 612.

### DETAILED DESCRIPTION OF EMBODIMENTS

The technical solutions in the embodiments of the present disclosure will be clearly and completely described below with reference to the drawings in the embodiments of the present disclosure. Obviously, the described embodiments are only some of the embodiments of the present disclosure, rather than all of the embodiments.

The present disclosure provides an automatic door opening and closing actuator, including a mounting housing and a push rod, wherein one end of the push rod extends out of a channel arranged in the mounting housing, and the other end of the push rod is arranged to slide reciprocally inside the mounting housing. The automatic door opening and closing actuator further includes a sealing tube sleeved outside the push rod. One end of the sealing tube is provided with a wrapping ring of an elastic material that wraps the push rod, and the other end of the sealing tube is hermetically fixed to an inner wall or one end of the channel.

An inner wall of the wrapping ring is provided with a circumferentially arranged first protruding ring. Two sides of the first protruding ring on the inner wall of the wrapping ring are each provided with at least one second protruding ring arranged at intervals. An oil groove for storing lubricating grease is formed between any adjacent first protruding ring and second protruding ring or between any two adjacent second protruding rings.

Both the first protruding ring and the second protruding rings are in interference fit with the push rod, and an annular center line of the first protruding ring is collinear with a center line of the push rod at a contact position between the first protruding ring and the push rod.

Compared with the prior art, the present disclosure has the following beneficial effects.

The overall structure of the actuator of the present disclosure adopts an internal swing-type actuator similar to that in the prior art, and thus the door is able to be opened and closed only by the extension and retraction of the push rod along the mounting housing. For this purpose, by providing an adaptive sealing tube between the channel of the mounting housing and the push rod, it can block a gap between the channel and the push rod. The wrapping ring used in cooperation with the push rod wraps outside the push rod and is able to realize sealed sliding with the push rod. Since both the first protruding ring and the second protruding rings are in interference fit with the push rod, external impurities can be effectively prevented from entering the mounting housing of the actuator along with the push rod. Moreover, the oil groove is arranged in the wrapping ring, and the lubricating grease is provided in the oil groove. The existence of the lubricating grease enables the push rod to slide smoothly along the wrapping ring. In addition, the annular center line of the first protruding ring is collinear with the center line of the push rod at the contact position between the first protruding ring and the push rod, which means that the first protruding ring is not or basically not affected by the movement of the push rod, and is able to always wrap around the outer wall of the push rod. This prevents external dust and water from entering the inside of the mounting housing through the gap between the wrapping ring and the push rod, so that the entire actuator has a good waterproof effect and is able to reach the protection level of IP6K7.

Further, the push rod extends along a curve to form a special-shaped rod structure.

Further, a cross-section of the push rod along a length direction of the push rod is circular.

Further, a cross-section of the push rod along a length direction of the push rod includes any one of a rectangle, a lantern shape, and an isosceles trapezoid.

Further, two second protruding rings exist. The two second protruding rings are respectively arranged on the two sides of the first protruding ring, and inner walls of the two second protruding rings are inclined relatively outward along the first protruding ring.

Further, the sealing tube includes a built-in supporting framework and an outer wrapping elastic layer, and the wrapping ring is connected to the elastic layer to form an integrated structure.

Further, the supporting framework is of a through-cavity structure. The wrapping ring is arranged at one end of the supporting framework, and another end of the supporting framework is provided with an annular plate extending vertically outward. A positioning plate extending and fixed in parallel is fixed on the annular plate, and the positioning plate is provided with a mounting through hole that is consistent with a direction of a through-cavity of the supporting framework. The elastic layer is arranged to wrap the supporting framework, the annular plate, and the positioning plate.

Further, the elastic layer wraps two sides of the annular plate and the positioning plate, and the elastic layer wrapping outside the annular plate and the positioning plate is provided with two annular sealing rings extending outward respectively on the two sides of the annular plate and the positioning plate.

Further, a plurality of connecting recesses are uniformly arranged on an outer wall of the supporting framework, and the elastic layer covers the plurality of connecting recesses and is attached and fixed to the supporting framework.

Further, the automatic door opening and closing actuator provided by the present disclosure further includes a drive assembly, a lead screw and a nut slider. The drive assembly is arranged inside the mounting housing, and is configured to drive the lead screw to rotate. The lead screw is rotatably arranged inside the mounting housing, and the nut slider is sleeved on the lead screw and threadedly connected to the lead screw. The end of the push rod located inside the mounting housing is hinged to the nut slider.

Further, a threaded through hole is arranged in the nut slider, and the lead screw is sleeved in the threaded through hole and in threaded transmission with the threaded through hole. A buffer nut of an elastic material is fixed on the nut slider, an inner ring of the buffer nut is provided with a spiral line in a same direction as the threaded through hole, and the buffer nut is sleeved outside the lead screw and threadedly connected to the lead screw in interference fit. Moreover, a center line of the buffer nut, a center line of the lead screw and a center line of the threaded through hole are collinearly arranged.

Further, the nut slider includes a built-in metal framework that is wrapped and fixed and an external plastic layer. A mounting through hole is arranged in the metal framework, a plastic nut is fixed in the mounting through hole, and an inner hole of the plastic nut is the threaded through hole.

Further, a mounting groove is arranged on the metal framework. A connecting end of the push rod is located in the mounting groove and hinged to the mounting groove through a pin screw. A center line of the pin screw is perpendicular to the center line of the threaded through hole.

A length direction of the push rod is parallel to a length direction of the lead screw, and the push rod rotates along the pin screw while moving with a rotation of the lead screw.

Further, a connecting hole communicated with the mounting groove is arranged in the nut slider. One end of the pin screw is fixed to a side wall of the mounting groove, and the other end of the pin screw is located in the mounting groove or the connecting hole.

Further, an outer wall of the plastic layer is in sliding contact with an inner wall of the mounting housing. The plastic layer is provided with a chamfered surface adapted to a bolt hole outside the mounting housing, and the chamfered surface is provided with an arc-shaped recessed area with a center of a circle facing outward.

Further, a mounting groove protruding outward along the threaded through hole is arranged on the nut slider, and the buffer nut is embedded and fixed in the mounting groove.

Further, the nut slider is provided with two inwardly recessed sliding grooves and an outwardly protruding auxiliary slider, and a length direction of the sliding grooves is arranged along a length direction of the lead screw.

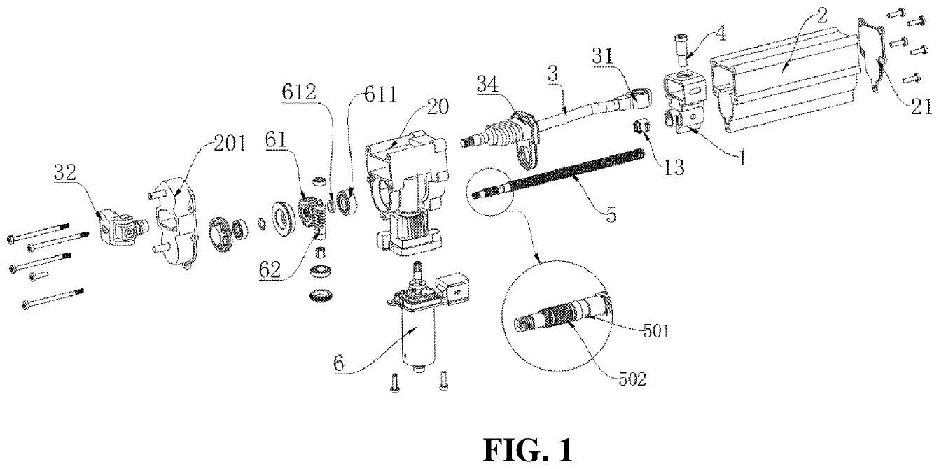

As shown in FIGS. 1-4, the present disclosure discloses an automatic door opening and closing actuator. The overall structure of the actuator is similar to that of the prior art, including a mounting housing 2, and a lead screw 5, a nut slider 1, a push rod 3 and a drive assembly that are mounted in cooperation with the mounting housing 2. The mounting housing 2 is used to integrate various components to realize the integrated installation of the actuator. Moreover, the mounting housing 2 is provided with a plurality of bolt holes 101 fixed to a vehicle body, thereby facilitating the fixation of the actuator and the vehicle body.

Considering the spatial layout, the mounting housing 2 has a hollow strip-shaped structure. The lead screw 5 is rotatably connected in the mounting housing 2 and arranged along a length direction of the mounting housing 2. The nut slider 1 is sleeved on the lead screw 5 and threadedly connected to the lead screw 5. Moreover, the nut slider 1 is slidably connected to an inner wall of the mounting housing 2. By defining a cross-sectional structure of the mounting housing 2, the movement of the nut slider 1 on the lead screw 5 can be limited without adding additional sliding pairs. The movement of the nut slider 1 is used to drive the push rod 3 to extend and retract. For this purpose, one end of the push rod 3 is located on the inner wall of the mounting housing 2 and hinged to the nut slider 1, and the other end of the push rod 3 extends out of the mounting housing 2 and is hinged to the vehicle body. The drive assembly is used to drive the lead screw 5 to rotate. The drive assembly adopts electric control drive, such as a motor (a program-controllable motor such as a servo motor or a stepping motor) arranged coaxially with the lead screw 5.

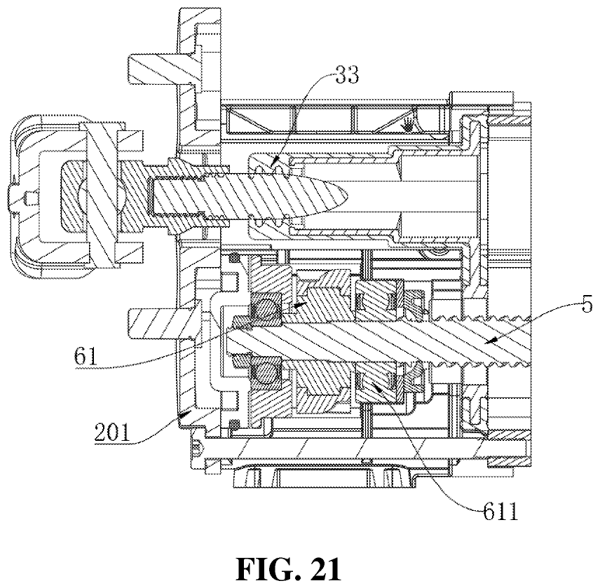

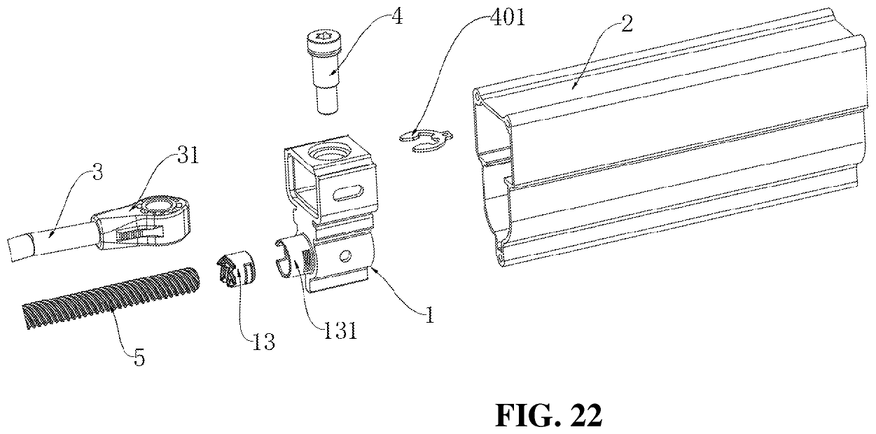

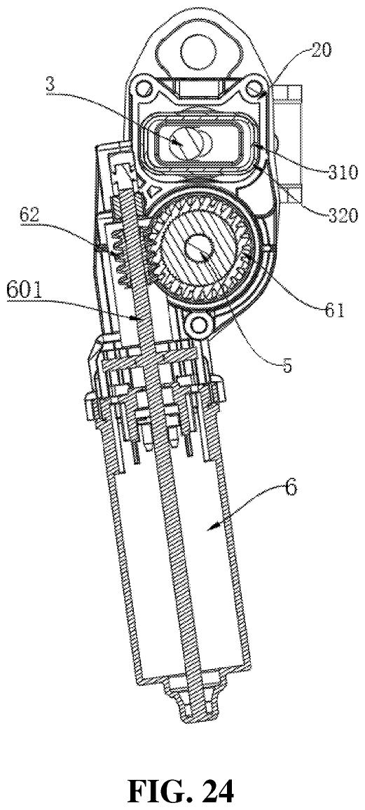

In some embodiments of the present disclosure, as shown in FIGS. 1, 2, 3, 4, 20, 21, and 24, the drive assembly adopts a servo motor 6 (a stepping motor or other motor capable of electric control), a worm 62, and a worm wheel 61 engaged with the worm 62. The worm 62 is arranged coaxially with the servo motor 6, and the worm wheel 61 is fixed coaxially to the lead screw 5.

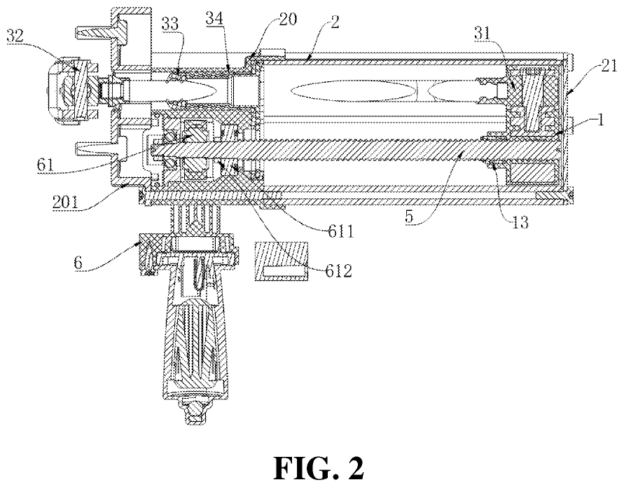

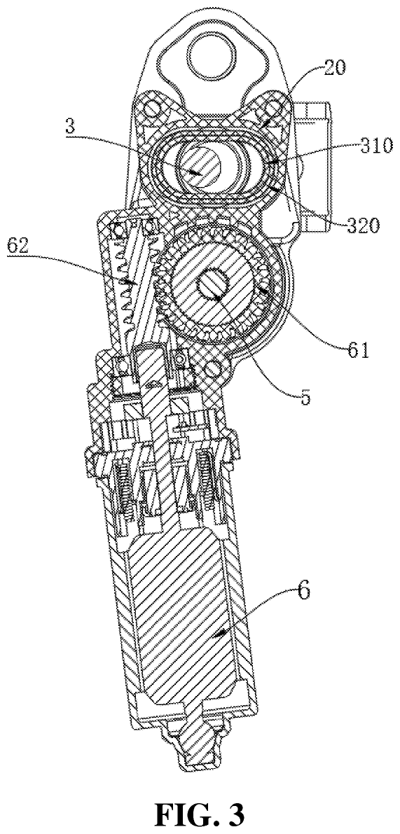

The worm 62 and the servo motor 6 can be connected by using the structure shown in FIGS. 1 and 3, that is, an output shaft 601 of the servo motor 6 is fixed to a lower end of the worm 62, and an upper end of the worm 62 is connected to a gearbox housing 20 through a bearing and rotatably arranged in the gearbox housing 20. Moreover, the assembly method of the worm wheel 61 and the lead screw 5 is as shown in FIGS. 1 and 2. A stop shaft sleeve 611 is mounted into the lead screw 5, moved to a first cylindrical section 501 of the lead screw 5 and riveted with the lead screw 5, and then inserted into the worm wheel 61 (an assembly of the worm wheel 61). The worm wheel 61 is provided with an internal spline, and the lead screw 5 is provided with an external spline section 502. The worm wheel 61 and the lead screw 5 are connected to realize coaxial rotation. Moreover, a circlip 612 is used to limit the mounting position of the worm wheel 61 on the lead screw 5 to ensure the positioning and assembly of the worm wheel 61 and the lead screw 5.

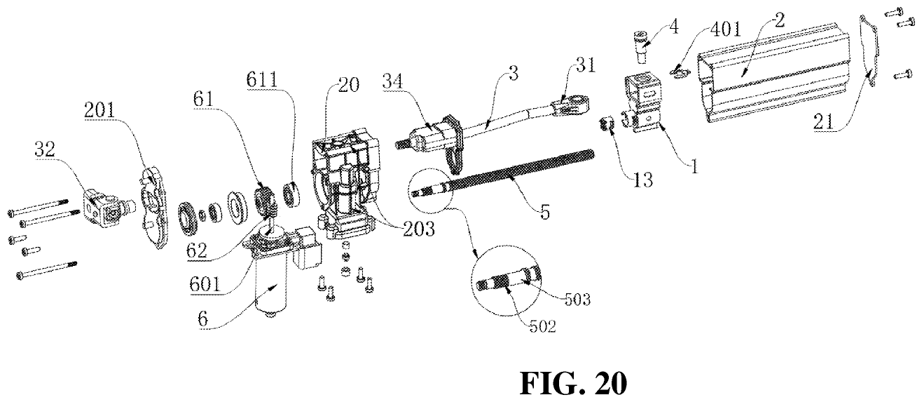

In addition to the above structure, the connection between the lead screw 5 and the worm wheel 61 and the connection between the worm 62 and the servo motor 6 can also be set with reference to the structures shown in FIGS. 20, 21, and 24. Specifically, the output shaft 601 of the servo motor 6 penetrates the worm 62 and is fixedly connected to the worm 62 through interference fit, and an upper end of the output shaft 601 is rotatably connected with the gearbox housing 20. The assembly of the worm wheel 61 and the lead screw 5 is as follows. The stop shaft sleeve 611 is fitted onto the lead screw 5, and the worm wheel 61 (the assembly of the worm wheel 61) is pressed onto the lead screw 5 through interference fit. The worm wheel 61 is provided with an internal spline and a cylindrical step. The internal spline is connected with the external spline section 502 on the lead screw 5, and the cylindrical step is in interference fit with a second cylindrical section 503 on the lead screw 5. The worm wheel 61 and the lead screw 5 are connected to realize coaxial rotation.

Compared with the structures shown in FIGS. 1 and 3, the assembly of the worm wheel 61 and the lead screw 5 and the assembly of the worm 62 and the servo motor 6 adopting the structures shown in FIGS. 20, 21, and 24 can significantly increase the connection stability between the worm 62 and the servo motor 6 to improve the service life of the entire device, and can further reduce the abnormal noise caused by the abnormal movement of the connection between the worm wheel 61 and the lead screw 5, thereby being more conducive to the mute treatment of door opening and closing.

Since the gearbox housing 20 is used to mount the drive assembly (the worm wheel 61 and the worm 62), to meet the assembly requirements of different assembly structures, a shape of the gearbox housing 20 in FIG. 1 is slightly different from that in FIG. 20. More reinforcing ribs 203 are arranged on the outside of the gearbox housing 20 in FIG. 20, so that a strength of the gearbox housing 20 is increased, and more importantly, the forming dimension precision of the gearbox housing 20 is able to be ensured, thereby adapting to the transmission requirements of the drive assembly in FIG. 20.

Moreover, since the worm 62 needs to be arranged perpendicular to the lead screw 5, the servo motor 6 can adopt a waterproof motor, and a relative position between the servo motor 6 and the mounting housing 2 is fixed with waterproof sealing, so as to prevent water or dust from entering the inside of the mounting housing 2 from a connection position between the servo motor 6 and the mounting housing 2. During use, the drive assembly acts upon receiving an instruction from a controller (an ECU of the vehicle body), and the drive assembly drives the lead screw 5 to rotate. The nut slider 1 reciprocates along a length direction of the lead screw 5 on the lead screw 5, thereby driving the push rod 3 to reciprocate and driving the door to open and close. When the door needs to hover, the controller continuously supplies power to the drive assembly, and the dynamic power can ensure that the door overcomes its own gravity and hovers at any slope and opening degree within the design requirements. Through the internal swing-type actuator structure of the present disclosure, the problem that the actuator has no motion envelope can be solved, and the function of facilitating door layout can be achieved.

Since the other end of the push rod 3 needs to extend out of the mounting housing 2 to be hinged to the vehicle body, a channel for the push rod 3 to pass through is arranged in the mounting housing 2. In this embodiment, two ends of the mounting housing 2 along its length are opened. One end of the mounting housing 2 is detachably and hermetically connected to an end cover 21, and another end of the mounting housing 2 is the channel. To make the entire actuator have a good waterproof function, it is necessary to seal a gap between the channel and the push rod 3. For this purpose, the present disclosure is also provided with a sealing sleeve.

Specifically, a sealing tube 34 is sleeved outside the push rod 3. One end of the sealing tube 34 is provided with a wrapping ring 33 of an elastic material that wraps the push rod 3, and the other end of the sealing tube 34 is hermetically fixed to an inner wall or one end of the channel. An inner wall of the wrapping ring 33 is provided with a circumferentially arranged first protruding ring 332. Two sides of the first protruding ring 332 on the inner wall of the wrapping ring 33 are each provided with at least one second protruding ring 331 arranged at intervals. An oil groove 333 for storing lubricating grease is formed between any adjacent first protruding ring 332 and second protruding ring 331 or between any two adjacent second protruding rings 331. Both the first protruding ring 332 and the second protruding rings 331 are in interference fit with the push rod 3, and an annular center line of the first protruding ring 332 is collinear with a center line of the push rod 3 at a contact position between the first protruding ring 332 and the push rod 3.

The entire sealing tube 34 can be made of plastic or rubber. If the entire sealing tube 34 is made of rubber, it is necessary to consider the connection method between the sealing tube 34 and the inner wall or end of the channel, and the dense connection between the sealing tube 34 and the channel can be realized by means of adhesive bonding. If the sealing tube 34 is made of plastic, the sealing tube 34 and the channel can be fixed by means of a buckle plus a gasket, or the sealing tube 34 and the channel can be hermetically connected by other fixing methods. The sealing tube 34 is arranged to block the gap between the push rod 3 and the channel, and the wrapping ring 33 is arranged to further prevent external impurities (such as water and dust) from entering the mounting housing 2 from the gap between the wrapping ring 33 and the push rod 3. Since the push rod 3 reciprocates during use, the arrangement of the wrapping ring 33 is further required to ensure the smooth movement of the push rod 3 while having a good waterproof effect. For this purpose, in this embodiment, the first protruding ring 332 and the second protruding rings 331 used in cooperation are arranged on the inner wall of the wrapping ring 33. Both the first protruding ring 332 and the second protruding rings 331 are in interference fit with the push rod 3, which is able to effectively prevent external impurities from entering the mounting housing 2 of the actuator along with the push rod 3. Moreover, the oil groove 333 is arranged in the wrapping ring 33, and the lubricating grease is provided in the oil groove 333. The existence of the lubricating grease enables the push rod 3 to slide smoothly along the wrapping ring 33. In addition, the annular center line of the first protruding ring 332 is collinear with the center line of the push rod 3 at the contact position between the first protruding ring 332 and the push rod 3, which means that the first protruding ring 332 is not or basically not affected by the movement of the push rod 3, and is able to always wrap around an outer wall of the push rod 3. This prevents external dust and water from entering the inside of the mounting housing 2 through the gap between the wrapping ring 33 and the push rod 3, so that the entire actuator has a good waterproof effect, and is able to reach a protection level of IP6K7.

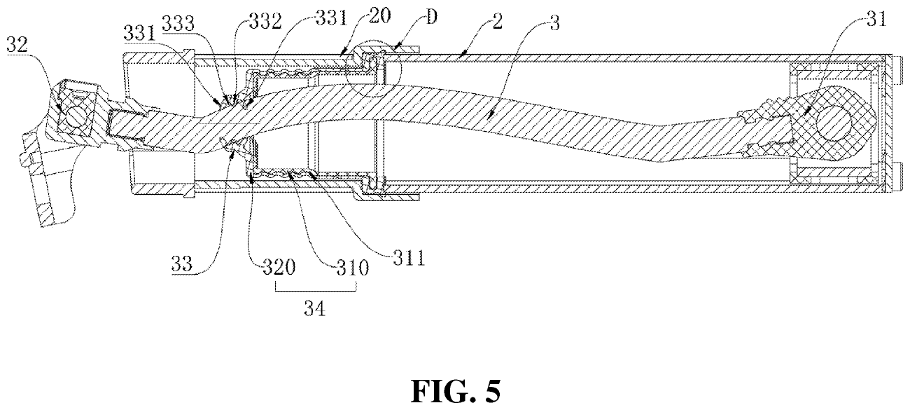

In another embodiment of the present disclosure, as shown in FIGS. 5, 7, and 11, the number of the second protruding rings 331 is two, and the two second protruding rings 331 are respectively arranged on two sides of the first protruding ring 332. The greater the number of the second protruding rings 331 is, the greater the thickness (length of a through cavity) of the corresponding wrapping ring 33 is, and thus the larger the contact area between the wrapping ring 33 and the push rod 3 is, which can affect the movement of the push rod 3. If only one second protruding ring 331 is provided, only one oil groove 333 can be formed. The oil storage effect of one oil groove 333 is not easy to control, and a distance between the first protruding ring 332 and the second protruding ring 331 should not be too large. In addition, if only one second protruding ring 331 is provided, forces on the two sides of the first protruding ring 332 are unbalanced. For this reason, in this embodiment, the two sides of the first protruding ring 332 are each provided with one second protruding ring 331, so as to ensure that the first protruding ring 332 is always able to be arranged concentrically with the contact part of the push rod 3 during the movement of the push rod 3. To further improve the retention effect of the two second protruding rings 331 on the lubricating oil, in this embodiment, inner walls of the two second protruding rings 331 are inclined relatively outward along the first protruding ring 332. In this way, when the push rod 3 passes through the first protruding ring 332, any second protruding ring 331 is able to scrape off the lubricating grease on the push rod 3, thereby ensuring that the lubricating grease is able to stay in the oil groove 333 for a long time and prolonging the service life.

In the prior art, the push rod 3 adopts a straight rod or a special-shaped rod. During the extension and retraction of the push rod 3 with a straight rod structure in the mounting housing 2, the mounting housing 2 also swings with the door, resulting in a certain swing angle of the push rod 3 during the extension and retraction. In this process, to make the wrapping ring 33 be always in interference fit with the push rod 3, the structure of the sealing tube 34 can be made of rubber, so that the side wall of the sealing tube can be bent and deformed to adapt to the movement of the push rod 3.

However, during the extension and retraction of the push rod 3 with the straight rod structure in the mounting housing 2, a large internal space is required, that is, the size of the mounting housing 2 is too large, which is not conducive to the door layout. Therefore, the use of the push rod 3 with a special-shaped rod structure can make the size of the entire mounting housing 2 smaller, which is more conducive to the spatial layout. For this purpose, in another embodiment of the present disclosure, to make the extension and retraction of the push rod 3 in the mounting housing 2 more stable, the push rod 3 extends along a curve to form the special-shaped rod structure. As shown in FIGS. 1 and 5, the push rod 3 has a strip-shaped structure. A sliding joint 31 is fixed at one end of the push rod 3 along its length direction, and the sliding joint 31 is hinged to the nut slider. A hinge part 32 is fixed at the other end of the push rod 3, and the hinge part 32 is connected to the vehicle body. The push rod 3 has a smoothly transitional curved structure along its length direction, presenting a special-shaped rod structure with a wave crest and a wave trough. Compared with the pull rod with the straight rod structure, the pull rod with the special-shaped rod structure is able to adapt to an angle change during the opening and closing of the door, thereby enabling the pull rod to extend and retract stably, further reducing the jitter during the opening and closing of the door, so as to make the opening and closing of the door more stable.

During the movement of the push rod 3 with the special-shaped rod structure, an offset position of the center line of the push rod 3 relative to the center line of the channel (or the wrapping ring 33) changes slightly with the movement of the push rod 3. In this case, the sealing tube 34 can be positioned and sealed using a plastic material, and it is only necessary to ensure that the wrapping ring 33 is made of rubber sleeved on the push rod 3 to achieve interference fit between the two. In the present disclosure, considering the mounting of the wrapping ring 33 on the sealing tube 34, the sealing tube 34 is arranged to be a double-layer structure consisting of a built-in supporting framework 310 and an outer wrapping elastic layer 320, and the wrapping ring 33 is connected to the elastic layer 320 to form an integrated structure.

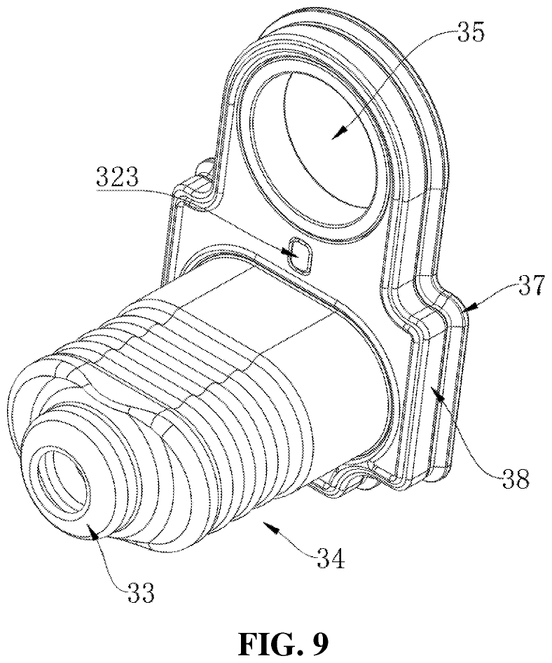

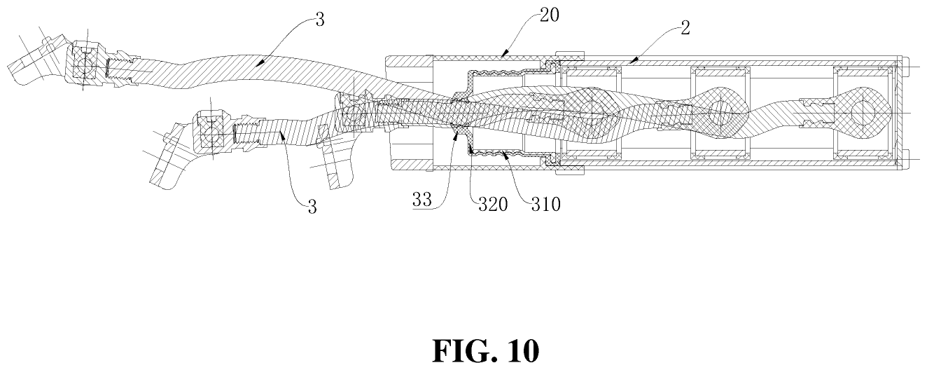

In theory, the sealing tube 34 can have a hollow cylindrical structure, a rectangular cavity structure, a hollow frustum of a cone structure, or any other through-cavity structure. The arrangement of the sealing tube 34 ensures that the push rod 3 is able to pass therethrough, the sealing tube 34 is able to be fixed to the channel of the mounting housing 2, and the push rod 3 is able to cooperate with the wrapping ring 33. For this purpose, the sealing tube 34 can have any structure that is able to achieve the above functions. In this embodiment, as shown in FIG. 10, considering a movement space (motion envelope) of each part of the push rod 3 with the special-shaped rod structure in the sealing tube 34 during movement, in this embodiment, as shown in FIG. 9, the sealing tube 34 adopts a flat structure with a large end and a small end. The wrapping ring 33 is arranged at the small end, and the large end is matched and fixed with the channel of the mounting housing 2. This structure is able to ensure that the push rod 3 is not affected by an internal cavity structure of the sealing tube 34 during movement, and is further able to ensure a secondary sealing connection between the sealing tube 34 and the push rod 3 and the mounting housing 2, thereby ensuring the sealing effect of the actuator.

To adapt to the push rod 3 with the special-shaped structure, in this embodiment, the sealing tube 34 is composed of inner and outer layers of materials. The supporting framework 310 can be an injection-molded part with sufficient hardness requirements. The elastic layer 320 can be made of rubber material to meet elasticity requirements. The supporting framework 310 and the elastic layer 320 can be fixedly connected either by two-shot injection molding or by overmolding process. The sealing tube 34 composed of the supporting framework 310 and the elastic layer 320 is able to meet both the stiffness requirements and the elasticity requirements, thereby ensuring that the position of the wrapping ring 33 of the sealing tube 34 (relative to the mounting housing 2 of the actuator) basically does not change with the movement of the push rod 3, so as to ensure that the wrapping ring 33 always wraps outside the push rod 3.

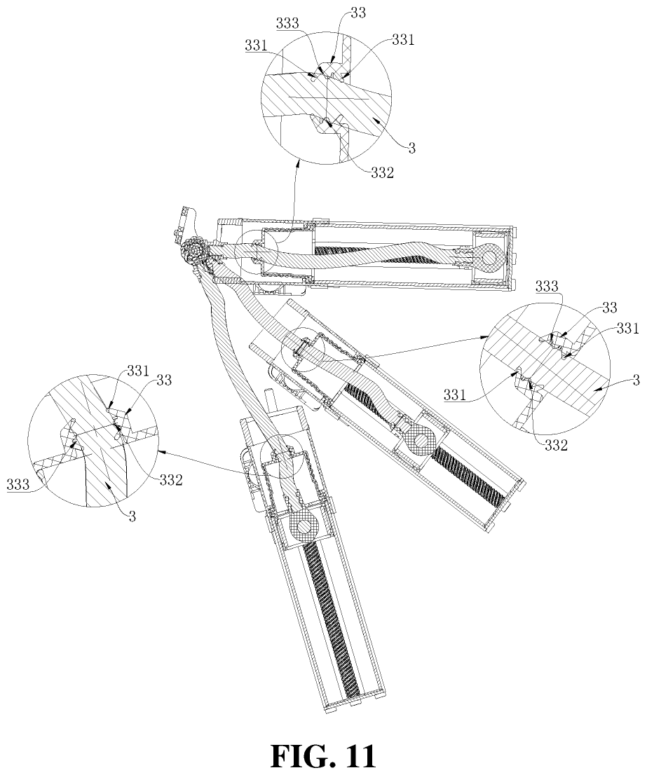

The use of the double-layer structured sealing tube 34 is able to ensure that the wrapping ring 33 is always in contact with the push rod 3, and the position of the wrapping ring 33 does not change due to the movement of the push rod 3. After ensuring the mounting position of the wrapping ring 33, the structure of the wrapping ring 33 is further arranged by adopting a first protruding ring 332 and at least two second protruding rings 331, which are able to form at least two oil grooves 333. Both the first protruding ring 332 and the second protruding rings 331 are in interference fit with the push rod 3, which is able to effectively prevent external impurities from entering the mounting housing 2 of the actuator along with the push rod 3. The oil grooves 333 are provided with the lubricating grease, and the existence of the lubricating grease enables the push rod 3 to slide smoothly along the wrapping ring 33, thereby realizing effective sealing of the push rod 3. As shown in FIG. 11, the annular center line of the first protruding ring 332 is collinear with the center line of the push rod 3 at the contact position between the first protruding ring 332 and the push rod 3, which means that the first protruding ring 332 is not or basically not affected by the movement of the push rod 3, and is able to always wrap around the outer wall of the push rod 3, thereby enabling the entire actuator to reach the protection level of IP6K7.

The wrapping ring 33 is designed to match the special-shaped structure of the push rod 3, so as to ensure that on the movement path of the push rod 3, the first protruding ring 332 of the wrapping ring 33 is able to always concentrically arranged with the push rod 3 at this position. For this purpose, a curved trend of the push rod 3 along its length direction is limited in the present disclosure.

Transformation is performed through a coordinate system.

An origin of the coordinate system is as follows.

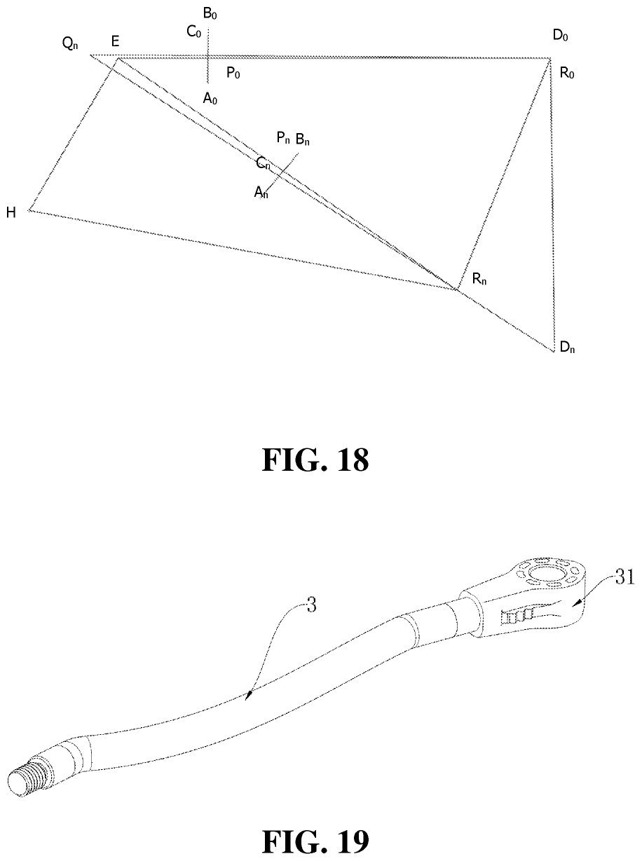

An intersection point of a hinge axis (an axis of a hinge connecting the door and the vehicle body) and a plane passing through a rotation center of the sliding joint 31 and perpendicular to the hinge axis is the origin. That is, a perpendicular intersection point H of a plane (a plane where FIG. 18 is located) passing through a center line of the sliding joint 31 and perpendicular to the hinge axis and the hinge axis is an origin of a relative coordinate system.

The Z-axis of the coordinate system: the Z-axis coincides with the hinge axis.

The X-axis of the coordinate system: the X-axis coincides with a vector direction from a rotation center of a fixed joint (hinge part 32) to the rotation center of the sliding joint 31, which is a connection line between midpoints of the hinge part 32 and the sliding joint 31, i.e., the center line of the push rod.

The relative coordinate system H-xyz is obtained. The actuator moves in an xy plane of this coordinate system, and a movement trajectory of the actuator is simplified as shown in FIG. 18.

In the figures:
Point H: the rotation center of the hinge;
Point E: the rotation center of the fixed joint;
Point Rₙ: the rotation center of the sliding joint;
Line segment CₙDₙ: the center line of the mounting housing (the mounting housing includes a gear housing and a mounting shell, and center lines of the gear housing and the mounting housing are collinear);
Line segment AₙBₙ: an inner contour line segment of the mounting housing;
Point Cₙ: a sealing set midpoint of the sealing tube (midpoint of the first protruding ring);
Point Pₙ: an intersection point of the inner contour line segment of the mounting housing and a connection line of the fixed joint center and the sliding joint center; and
Point Qₙ: an intersection point of the center line of the mounting housing at any opening degree and the center line of the mounting housing at an initial opening degree.

From the above simplified model, it can be obtained that during the entire operating opening degree of the door, points E and H are fixed; points C and D rotate around point H, a length of the actuator center line segment CD remains unchanged, and a rotation angle of the line segment CD is the door opening degree a; and point R rotates around point E while maintaining a length of the line segment ER unchanged. A length |CₙPₙ| is a deviation length of the push rod center line ER from the sealing set midpoint Cₙ. By compensating for this deviation length at a full opening degree, the push rod center line ER can form a push rod curve that is able to ensure the sealing function.

Through the assembly of the actuator in the door, the known items can be obtained as follows:
Hₓ, H_{y}, Eₓ, E_{y}, D₀ₓ, D_{0y}, R₀ₓ, R_{0y}, C₀ₓ, C_{0y}, |CH|, |DH|, |ER|.

Through geometric relationships, θ (a rotation angle of the line segment ER around point E) corresponding to any opening degree a and an included angle γ between the actuator center line CD and the push rod center line ER can be obtained.

The door opening degree a is generally 0°~72°, and an opening degree increment Aa is set to 1° (the smaller the increment is, the higher the precision is), so that 73 point coordinates Pₙ where the push rod center line ERₙ deviates from the sealing set point Cₙ at various opening degrees can be obtained:

$${P}_{n x} = {C}_{n x} + \vert {C}_{n} {P}_{n} \vert * sin ( θ - γ ) ;$$

$${P}_{n y} = {C}_{n y} - \vert {C}_{n} {P}_{n} \vert * cos ( θ - γ ) .$$

By reversely rotating the point Pₙ obtained at each opening degree around point E by θ, a coordinate Pₙ′ of point Pₙ when the door is in a closed position can be obtained:

$${P}_{n x}^{′} = {P}_{n x} + {P}_{n y} * tan \frac{θ}{2} ;$$

$${P}_{n y}^{′} = 0 .$$

Through the geometric relationships, a coordinate Cₙ′ of point Cₙ when it is reversely rotated around point E by θ and the door is in the closed position can be obtained:

$${C}_{n x}^{′} = {P}_{n x}^{′} + \vert {C}_{n} {P}_{n} \vert * sin γ ;$$

$${C}_{n y}^{′} = 0 + \vert {C}_{n} {P}_{n} \vert * cos γ .$$

The coordinates of each point Cₙ′ can be imported through 3D design software such as CATIA or UG, and a curved structure of the push rod 3 as shown in FIG. 19 is generated from this set of points.

The push rod 3 based on this curved shape can ensure an optimal cooperation with the wrapping ring 33, thereby avoiding a sealing failure due to gap(s) between the push rod 3 and the multiple protruding rings inside the wrapping ring 33 during movement, so as to ensure the sealing effect between the push rod 3 and the wrapping ring 33.

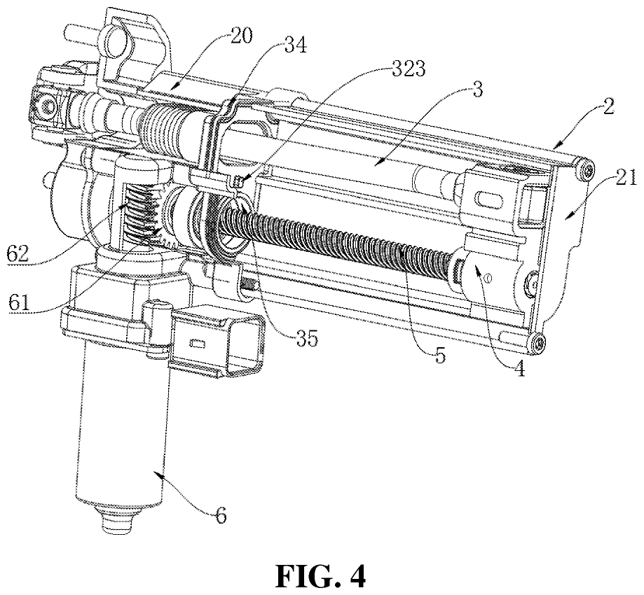

The push rod 3 has the special-shaped rod structure along its length. This shape of push rod 3 is able to effectively cooperate with the sealing tube 34 of the above structure, thereby achieving a double sealing effect between the sealing tube 34 and the push rod 3, and between the sealing tube 34 and the mounting housing 2. It is only necessary to ensure that the inner cavity structure of the wrapping ring 33 is matched with a cross-sectional structure of the push rod 3. For this purpose, a cross-section of the push rod 3 along its length direction can be any one of circular, rectangular, lantern-shaped, isosceles trapezoidal, etc. In another embodiment of the present disclosure, considering a wear effect between the push rod 3 and the wrapping ring 33, in this embodiment, as shown in FIGS. 3 and 4, the cross-section of the push rod 3 along its length direction is circular. The push rod 3 with a circular cross-section can reduce the wear of the wrapping ring 33 and improve the service life of the sealing tube 34.

In another embodiment of the present disclosure, to increase the contact area between the supporting framework 310 and the elastic layer 320, and thus to improve the connection stability between the supporting framework 310 and the elastic layer 320, in this embodiment, a plurality of connecting recesses 311 are uniformly arranged on an outer wall of the supporting framework 310, and the elastic layer 320 covers the plurality of connecting recesses 311 and is attached and fixed to the supporting framework 310. The structure of the connecting recess 311 can be annular or strip-shaped, and its purpose is to increase a contact area between the outer wall of the supporting framework 310 and the elastic layer 320 through the arrangement of the plurality of connecting recesses 311. As shown in FIG. 9, in this embodiment, the plurality of connecting recesses 311 are arranged side by side along a direction of a through cavity of an annular structure, and each connecting recess 311 has an annular groove structure arranged circumferentially along the direction of the through cavity of the annular structure. This structure is able to realize a large contact area between the supporting framework 310 and the elastic layer 320, thereby further improving the connection stability between the supporting framework 310 and the elastic layer 320.

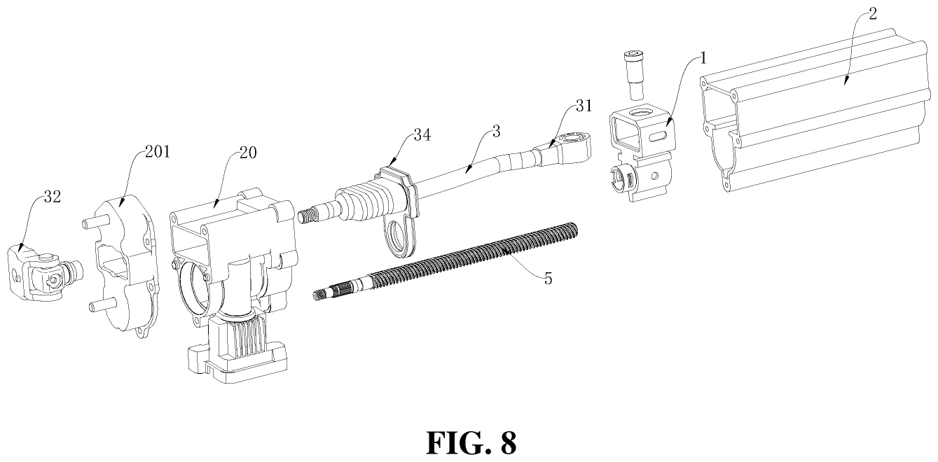

To facilitate the connection between the sealing tube 34 and the mounting housing 2, and to achieve the sealing connection between the drive assembly and the mounting housing 2, as shown in FIGS. 1, 2, 7, and 8, the gearbox housing 20 is connected to one end of the mounting housing 2 where the channel is provided. A lower end of the gearbox housing 20 is opened and hermetically connected to a housing of the servo motor 6. The worm wheel 61 and the lead screw 5 are arranged in the gearbox housing 20. The gearbox housing 20 is provided with a through slot along the length direction of the lead screw 5. One end of the through slot of the gearbox housing 20 is sleeved on the outer wall of the mounting housing 2, and a snapping plate that is set at an interval from an open end of the mounting housing 2 is arranged on an inner wall of the gearbox housing 20. The snapping plate and the open end of the mounting housing 2 form an annular snapping groove 202 for mounting the sealing tube 34. A hermetically connected cover plate 201 is provided at another end of the through slot of the gearbox housing 20, and the cover plate 201. The gearbox housing 20, and the mounting housing 2 are locked by connecting bolts to fasten, and the sealing tube 34 is locked and fixed. To adapt the sealing tube 34 to the annular snapping groove 202, the structure of the supporting framework 310 is limited in the present disclosure. Specifically, the supporting framework 310 has a through cavity structure. The wrapping ring 33 is arranged at one end of the supporting framework 310, and another end of the supporting framework 310 is provided with an annular plate 312 extending vertically outward. A positioning plate 351 extending and fixed in parallel is fixed on the annular plate 312, and the positioning plate 351 is provided with a mounting through hole 35 that is consistent with a direction of the through cavity of the supporting framework 310. The elastic layer 320 is arranged to wrap the supporting framework 310, the annular plate 312, and the positioning plate 351. The elastic layer 320 wraps two sides of the annular plate 312 and the positioning plate 351, and the elastic layer 320 wrapping outside the annular plate 312 and the positioning plate 351 is provided with two annular sealing rings extending outward respectively on the two sides of the annular plate 312 and the positioning plate 351.

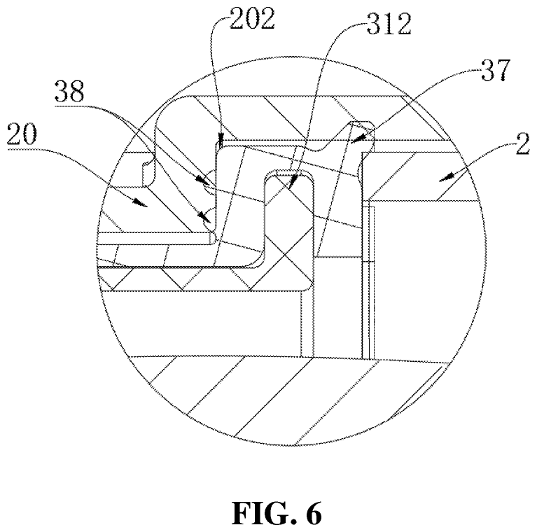

As shown in FIGS. 5, 6, and 9, the mounting through hole 35 arranged in the positioning plate 351 facilitates the mounting of the lead screw 5, allowing the lead screw 5 to pass therethrough. Moreover, the arrangement of the positioning plate 351 is also able to increase an extension area of the annular plate 312 toward the lead screw 5. Moreover, this arrangement also facilitates the supporting framework 310, the annular plate 312, and the positioning plate 351 to form an integrated supporting structure, and this integrated supporting structure can be formed by injection molding. The external elastic layer 320 is fixed to the internal supporting structure by overmolding or two-shot injection molding. Moreover, due to the plug-in fit between the auxiliary housing and the mounting housing 2, the annular snapping groove 202 for mounting the sealing tube 34 is able to be formed, and the annular plate 312 and the positioning plate 351 are able to form a snapping plate snapped to the annular snapping groove 202. To realize the sealing connection between the snapping plate and the annular snapping groove 202, the two annular sealing rings are provided. The two annular sealing rings are in sealed contact with side walls of the annular snapping groove 202 to form a labyrinth-structured sealing structure, thereby realizing the double-layer sealed fixation between the sealing tube 34 and the gearbox housing 20 and between the sealing tube 34 and the mounting housing 2. The two annular sealing rings can be of the same structure or different structures according to their functions and structures. In this embodiment, as shown in FIGS. 5, 6, and 9, the two annular sealing rings have slightly different structures, namely a first annular sealing ring and a second annular sealing ring. The first annular sealing ring mainly abuts against a side close to the wrapping ring 33, and the second annular sealing ring is close to a position corresponding to a circumference of the annular plate 312. This way is more conducive to the sealed fixation between the sealing tube 34 and the gearbox housing 20 and the sealing tube 34 and the mounting housing 2.

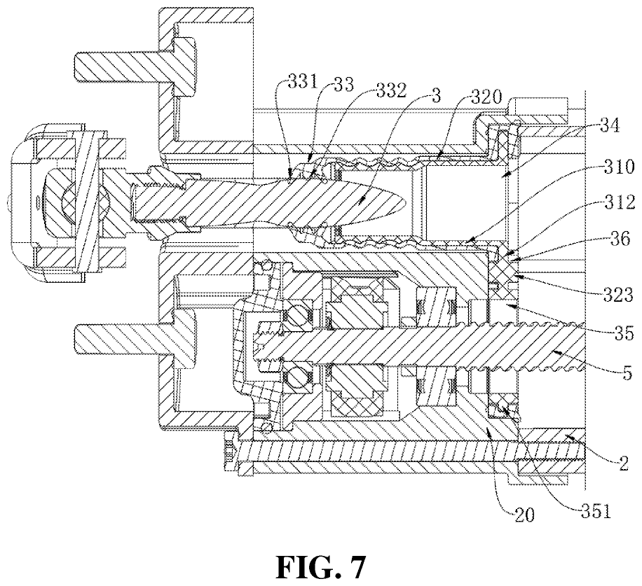

To improve the connection effect between the outer wrapping layer (elastic layer 320) and the built-in framework (supporting structure), as shown in FIGS. 7 and 4, a connecting through hole 36 is provided between the positioning plate 351 and the annular plate 312, and the outer wrapping elastic layer 320 passes through the connecting through hole 36 and forms a barrier block 323, which is used to enhance the connection effect between the outer wrapping layer and the framework.

During mounting, after the second annular sealing ring 322 is in interference fit with the gear housing 20, the gear housing 20 equipped with a sealing structure 3 is snapped at an end position of the mounting housing 2 and fixed by connecting bolts, thereby realizing the sealing connection between the sealing structure 3 and the mounting housing 2 and between the sealing structure 3 and the gear housing 20.

Based on the above actuator structure, the waterproof effect verification is carried out.

### 1. Test Standards

Dustproof test standard: ISO 20653-2013; and Waterproof test standard: GB/T 4208-2017.

### 2. Test Requirements

(1) Waterproof test requirements:
Immersion depth: 1 m; Immersion time: 30 min;
(2) Dustproof requirements:
\textcircled{1} Dust type: Arizona A2 dust;
\textcircled{2} Dust dosage: 2 kg/m³;
\textcircled{3} Test time: 6 s of dust blowing, 15 minutes of pause, 20 cycles.
   3. Evaluation results
(1) After being taken out of water, the product operated normally;
(2) No water or dust entered the product.

Through the sealing tube 34 of the present disclosure, the problem of dustproof and waterproof of the sliding part of the push rod 3 of the actuator and the mounting housing 2 can be solved, thereby enabling the actuator to reach the protection level of IP6K7.

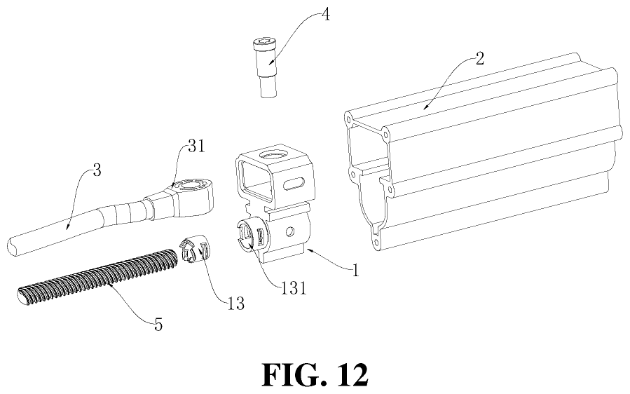

In another embodiment of the present disclosure, to reduce abnormal noise during the use of the actuator, the sliding pair structure of the actuator is also improved in the present disclosure. As shown in FIGS. 1 and 12, the sliding pair structure includes the nut slider 1, the push rod 3 and the lead screw 5. The push rod 3 and the lead screw 5 are horizontally arranged, and the lead screw 5 is rotatably provided in the mounting housing 2. A threaded through hole 181 is arranged in the nut slider 1, the lead screw 5 is sleeved in the threaded through hole 181 and in threaded transmission with the threaded through hole 181, and the nut slider 1 is in contact with and slidably arranged on the inner wall of the mounting housing 2. The push rod 3 is located above the lead screw 5. Moreover, one end of the push rod 3 extends out of the mounting housing 2 and is hinged to the door or the vehicle body, and the other end of the push rod 3 is hinged to the nut slider 1. When the lead screw 5 rotates under the action of the drive assembly, the nut slider 1 threadedly connected to the lead screw 5 moves along the length direction of the lead screw 5, so as to drive the push rod 3 to extend out of the mounting housing 2 and drive the door to rotate along the hinge point between the door and the vehicle body, thereby realizing the opening and closing of the door.

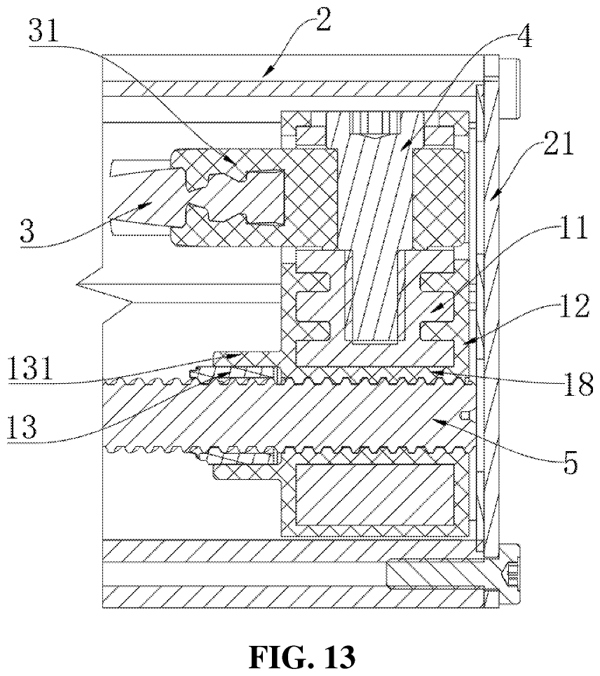

During use, as the push rod 3 moves with the nut slider 1, the other end of the push rod 3 also rotates with the hinge point between the push rod 3 and the nut slider 1, resulting in an additional force on the nut slider 1 along a radial direction of the lead screw 5. Combined with the transmission gap between the nut slider 1 and the lead screw 5, the nut slider 1 moves obliquely along an axial direction of the lead screw 5, causing the push rod 3 to have a lost motion, thereby increasing a lost motion at an edge of the door. Moreover, when switching the door back and forth, the lost motion of the push rod 3 causes a “clanging” abnormal noise of the door. To solve this problem, a buffer nut 13 is also arranged in the present disclosure. As shown in FIGS. 12, 13 and 14, the buffer nut 13 is fixed to the nut slider 1. An inner ring of the buffer nut 13 is provided with a spiral line in the same direction as the threaded through hole 181, and the buffer nut 13 is sleeved on the lead screw 5 and threadedly connected to the lead screw 5 in interference fit. Moreover, a center line of the buffer nut 13, the center line of the lead screw 5 and a center line of the threaded through hole 181 are collinearly arranged. The buffer nut 13 can be arranged at either end of the threaded through hole 181 or inside the threaded through hole 181. Considering the convenience of production and processing, the buffer nut 13 is arranged at either end of the threaded through hole 181 and connected to the threaded through hole 181. Specifically, the nut slider 1 is provided with a mounting recess 131 protruding outward along the threaded through hole 181, and the buffer nut 13 is embedded in the mounting recess 131. The buffer nut 13 and the mounting recess 131 can be fixed by means of interference fit, as long as the buffer nut 13 and the nut slider 1 are fixedly connected. The buffer nut 13 and the mounting recess 131 can also be fixed by means of key connection, as long as the buffer nut 13 and the nut slider 1 are fixedly connected. As shown in FIG. 13, in this embodiment, the buffer nut 13 is arranged at one end of the threaded through hole 181 close to the push rod 3 (the left position in the figure), so that the mounting recess 131 of the nut slider 1 can extend into the gearbox (the housing where the drive assembly is mounted in cooperation). If the buffer nut 13 is arranged at the right side of the threaded through hole 181 in the figure, a length dimension of the product increases, which is not conducive to miniaturization.

The additional buffer nut 13 of the present disclosure is fixed to the nut slider 1 and also in interference fit with the lead screw 5, and the spiral line of the inner ring of the buffer nut 13 is the same as that of the threaded through hole 181. This means that during the rotation of the lead screw 5, the threaded through hole 181 moves and provides sufficient driving force to force the buffer nut 13 to move together with the nut slider 1. While ensuring that the movement of the nut slider 1 is not affected, it can also eliminate the transmission gap between the lead screw 5 and the threaded through hole 181, thereby ensuring that the center line of the buffer nut 13, the center line of the lead screw 5, and the center line of the threaded through hole 181 always remain collinear during operation. This ensures that the lead screw 5 and the nut are not skewed during the opening and closing of the door, making the opening and closing of the door smoother, thus reducing the lost motion during the opening and closing of the door, thereby reducing the door shake, and eliminating the “clanging” abnormal noise generated during the opening and closing of the door.

To reduce wear, not affect the transmission of the nut slider 1 and reduce transmission noise, the buffer nut 13 of the present disclosure is made of elastic material. The elastic material can be rubber material, silicone rubber material, polyurethane elastomer, polyester elastomer in the prior art. In this embodiment, the buffer nut 13 is made of rubber material. The rubber has a certain elasticity. It can tightly wrap the lead screw 5 and move together with the nut slider 1 under an action of external extrusion force (a transmission force between the rotation of the lead screw 5 and the threaded through hole 181), thereby ensuring that the nut slider 1 is able to slide back and forth on the lead screw 5.

In the prior art, a slider is entirely made of metal material to ensure sufficient stiffness and strength for long-term use. Moreover, a plastic inner liner threadedly connected to a lead screw 5 is arranged in a threaded hole of the slider to reduce transmission noise and ensure the stability of a mutual movement between the slider and the lead screw 5. However, an outer wall of the slider needs to be in sliding contact with an inner wall of a mounting housing 2 of an actuator. A through slot of the mounting housing 2 is made of metal material. If the slider is made of metal material, a rigid contact between the two results in large friction noise. To solve this problem, in another embodiment of the present disclosure, the nut slider 1 (equivalent to the slider in the prior art) adopts a double-layer structure, including a built-in metal framework 11 that is wrapped and fixed and an external plastic layer 12. A mounting through hole 35 is arranged in the metal framework 11, a plastic nut 18 is fixed in the mounting through hole 35, and an inner hole of the plastic nut 18 is a threaded through hole 181. As shown in FIGS. 13, 14, 15, 16, and 17, the nut slider 1 of the present disclosure includes a three-layer structure from the inside to the outside. A plastic nut 18 is a first-layer structure. The plastic nut 18 and the threaded through hole 181 are fixed by interference fit or key connection, or the plastic nut 18 can be fixed to the threaded through hole 181 together with the plastic layer 12 by means of two-shot injection molding. The plastic nut 18 is in threaded transmission connection with the lead screw 5, which reduces transmission noise, has better wear resistance, and enables the entire nut slider 1 to slide stably on the lead screw 5. The metal framework 11 is a second layer. The arrangement of the metal framework 11 is able to ensure that the entire nut slider 1 has sufficient stiffness and strength. The metal framework 11 can be formed by die-casting using aluminum alloy or zinc alloy. An outermost plastic layer 12 is in sliding contact with the inner wall of the mounting housing 2, and the plastic layer 12 is obtained by overmolding or two-shot injection. Therefore, the overall structure of the nut slider 1 is actually determined by the metal framework 11. Compared with a general method of using a middle metal core (cylindrical core), the metal framework 11 has better strength and stiffness. The outer wrapping plastic layer 12 is able to ensure that a contact part between the nut slider 1 and the inner wall of the mounting housing 2 is made of plastic material. The sliding friction of the plastic material has the effect of vibration reduction and noise reduction, thereby making the noise of the nut slider 1 of the present disclosure smaller during movement in the mounting housing 2.

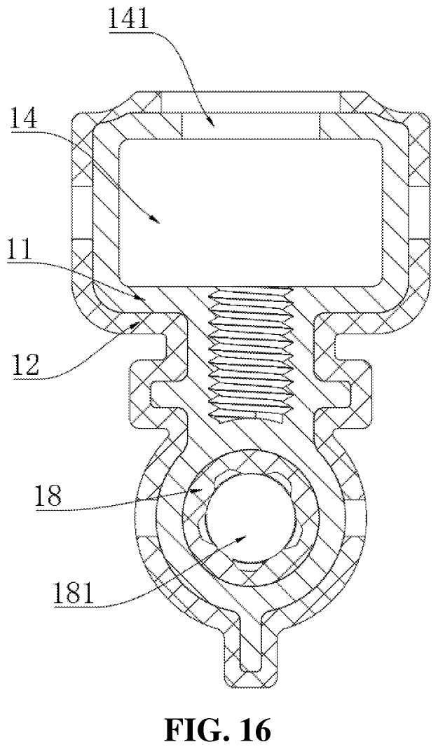

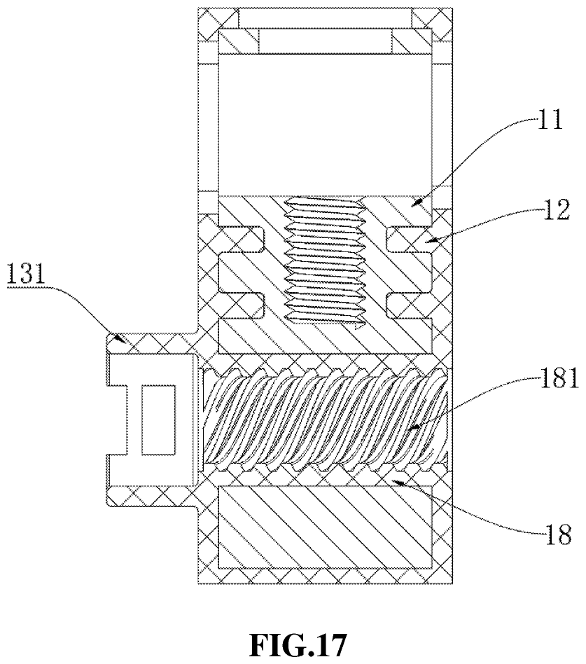

To reduce a distance between the center line of the push rod 3 and the center line of the lead screw 5 to improve work efficiency, the push rod 3 of the present disclosure is embedded in the nut slider 1 and hinged to the nut slider 1. To ensure a more stable connection between the push rod 3 and the nut slider 1, the push rod 3 is connected to the metal framework 11. Specifically, a mounting groove 14 is arranged on the metal framework 11, and a connecting end of the push rod 3 is located in the mounting groove 14 and hinged to the mounting groove 14 through a pin screw 4. A center line of the pin screw 4 is perpendicular to the center line of the threaded through hole 181. The length direction of the push rod 3 is parallel to the length direction of the lead screw 5, and the push rod 3 rotates along the pin screw 4 while moving with the rotation of the lead screw 5. As shown in FIGS. 16 and 17, the mounting groove 14 can adopt a rectangular groove structure or a rectangular through-cavity structure. The arrangement of the mounting groove 14 facilitates the embedding of the end of the push rod 3 in the mounting groove 14. Two side walls of the mounting groove 14 limit the swing angle of the push rod 3, and the fixing of the pin screw 4 and the metal framework 11 is able to provide sufficient connection strength, thereby making the connection between the push rod 3 and the nut slider 1 more stable. In this embodiment, the mounting groove 14 adopts the rectangular through-cavity structure, a direction of the rectangular through-cavity is consistent with the length direction of the lead screw 5, and one end of the sliding joint 31 of the push rod 3 is embedded in the mounting groove 14. The above structure can minimize the distance between the center line of the push rod 3 and the center line of the lead screw 5, with a design limit of less than 20 mm. The push rod 3 (sliding joint 31) is firmly fixed on the nut slider 1, and can rotate around the pin screw 4, so that the internal space of the actuator can be provided more compactly, thereby reducing the space occupation ratio of the actuator, which is more conducive to the mounting and layout of the actuator on different types of doors.

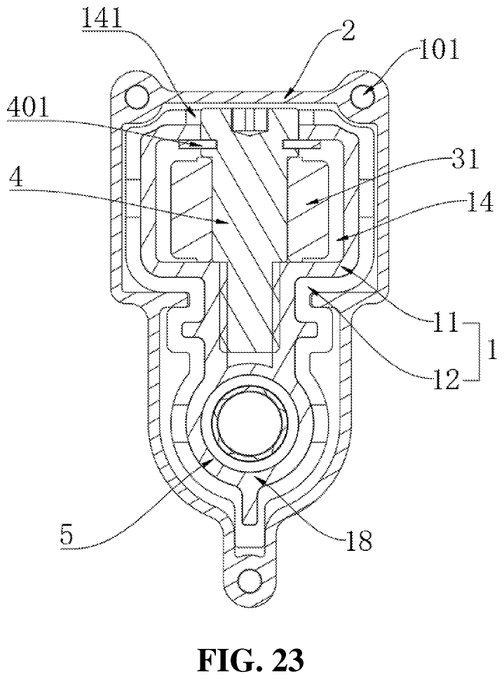

To avoid the pin screw 4 extending out of the nut slider 1 and contacting the inner wall of the mounting housing 2, which results in rigid sliding abnormal noise, and to facilitate the mounting of the pin screw 4, in another embodiment of the present disclosure, a connecting hole 141 communicated with the mounting groove 14 is arranged in the nut slider 1. One end of the pin screw 4 is fixed to a side wall of the mounting groove 14, and another end of the pin screw 4 is located in the mounting groove 14 or the connecting hole 141. As shown in FIGS. 16 and 17, since the plastic layer 12 wraps along an outer side of the metal framework 11, the corresponding connecting hole 141 arranged in the metal framework 11 does not be wrapped by the plastic layer 12. During mounting, the pin screw 4 is inserted into the through holes arranged in the mounting groove 14 and the sliding joint 31 of the push rod 3 from the connecting hole 141, and is fastened to the threaded hole of the metal framework 11, so that the assembly of the push rod 3 and the nut slider 1 is able to be completed. Since the pin screw 4 is able to limit the push rod 3 in an up and down direction, the movement of the push rod 3 is more stable. During long-term use, the pin screw 4 may partially withdraw from the metal framework 11 due to external influences, leading to the failure of the stable connection between the push rod 3 and the nut slider 1. To solve this problem, the present disclosure also provides some embodiments. As shown in FIGS. 20 and 23, the pin screw 4 is further provided with a matching retaining ring 401. After the pin screw 4 is assembled with the push rod 3 (the sliding joint 31) and the metal framework 11, the retaining ring 401 is inserted and snapped at a nut position of the pin screw 4 along a direction of the through slot of the mounting groove 14. Moreover, the size (minimum width) of the retaining ring 401 is greater than the size (maximum width) of the connecting hole 141, which ensures that the pin screw 4 does not withdraw from the metal framework 11 along an axial direction of the pin screw 4. The use of the retaining ring 401 ensures the connection stability between the pin screw 4 and the metal framework 11, thereby increasing the service life of the equipment, and reducing the number of inspections and maintenance.

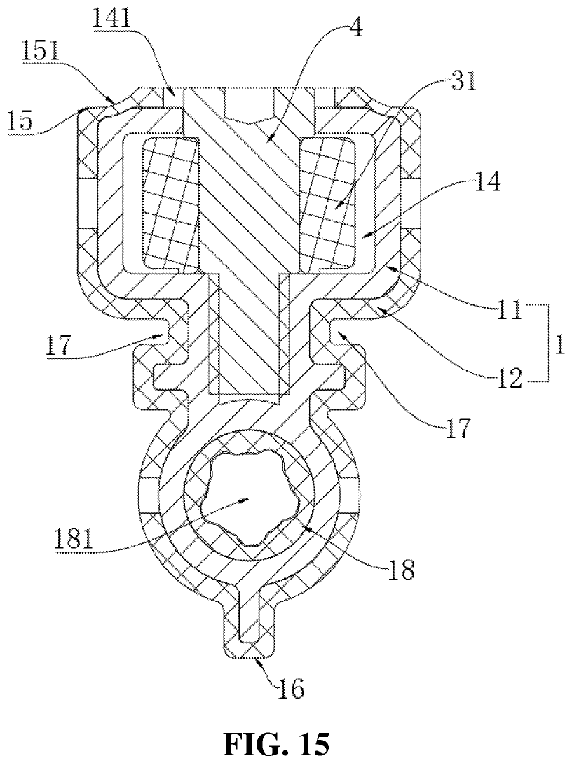

The mounting housing 2 needs to be fixed to the door. For this purpose, bolt hole(s) 101 are arranged in the outer side of the mounting housing 2. To ensure the connection stability between the mounting housing 2 and the door, a thickness of the outer wall corresponding to the bolt hole 101 is required to be consistent, which means that the position of the outer wall corresponding to the bolt hole 101 protrudes toward the inner wall of the mounting housing 2. In another embodiment of the present disclosure, to make the overall structure of the actuator more compact, the plastic layer 12 is provided with chamfered surface(s) 15 adapted to the bolt hole(s) 101 outside the mounting housing 2, and the chamfered surface 15 is provided with an arc-shaped recessed area 151 with a center of a circle facing outward. As shown in FIGS. 15 and 16, two relatively inclined chamfered surfaces 15 are arranged at upper corner positions of the plastic layer 12, and the arc-shaped recessed area 151 with the center of the circle facing outward is arranged in the middle of the chamfered surface 15. The arc-shaped recessed area 151 is adapted to the position protruding toward the inner wall of the mounting housing 2 corresponding to the bolt hole 101. The arrangement of this structure is able to further reduce the design size of the mounting housing 2, thereby further ensuring the compactness of the overall structure of the actuator.

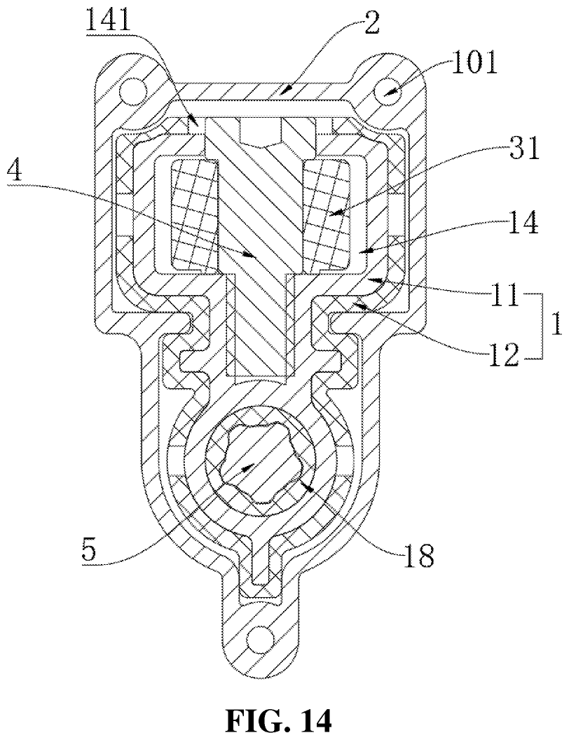

In the prior art, for the sliding of the nut slider 1 in the mounting housing 2, a sliding groove or an outwardly protruding sliding block is arranged on the nut slider 1, and a matching sliding block or sliding groove is arranged on the inner wall of the mounting housing 2, thereby ensuring that the nut slider 1 is able to be slidably limited when moving on the lead screw 5. However, in the prior art, the sliding block or sliding groove is arranged between the lead screw 5 and the push rod 3 or above the push rod 3, which is not conducive to the stable movement of the sliding block. For this reason, in another embodiment of the present disclosure, the nut slider 1 is provided with two inwardly recessed sliding grooves 17 and an outwardly protruding auxiliary sliding block 16. A length direction of the sliding groove 17 is arranged along the length direction of the lead screw 5. As shown in FIG. 14, the two sliding grooves 17 are arranged between the lead screw 5 and the push rod 3, and the auxiliary sliding block 16 is located below the lead screw 5. This layout is able to provide limiting support force for the lead screw 5 in upper and lower directions, thereby ensuring that the nut slider 1 slides smoothly along the lead screw 5 with better stability.

For those skilled in the art, it is obvious that the present disclosure is not limited to the details of the above exemplary embodiments, and the present disclosure can be implemented in other specific forms without departing from the spirit or basic characteristics of the present disclosure. Therefore, from any point of view, the embodiments should be regarded as exemplary and non-restrictive. The scope of the present disclosure is defined by the appended claims rather than the above description, and thus it is intended to include all changes falling within the meaning and scope of equivalent elements of the claims in the present disclosure. Any reference signs in the claims should not be construed as limiting the involved claims.

### INDUSTRIAL APPLICABILITY

The automatic door opening and closing actuator provided by the present disclosure is applicable to the technical field of automobile components. By providing the sealing tube and the wrapping ring structure, the gap between the channel of the mounting housing and the push rod is blocked, preventing external dust and water from entering the interior of the mounting housing, so that the entire actuator has a good waterproof effect and can reach a protection level of IP6K7. The sealing tube includes a built-in supporting framework and an outer wrapping elastic layer. An inner wall of the wrapping ring is provided with a first protruding ring and second protruding rings, and an oil groove for storing lubricating grease is formed therebetween. This structure, while effectively blocking impurities from entering, ensures smooth sliding of the push rod along the wrapping ring, thereby achieving effective sealing.

The push rod is configured as a special-shaped rod structure extending along a curve, which ensures that a center line of the push rod is always approximately collinear with the first protruding ring in the wrapping ring of the sealing tube, making the opening and closing of the door more stable.

The nut slider includes a built-in metal framework and an external plastic layer, and is additionally provided with a buffer nut of an elastic material. The buffer nut is in interference fit with the lead screw and is collinearly arranged with a center line of a threaded through hole in the nut slider, effectively eliminating a transmission gap of the lead screw, reducing a lost motion and abnormal noise during door opening and closing, and making the door opening and closing smoother.

In summary, on the basis of maintaining the compact structure of the internal swing-type actuator and facilitating layout, the present disclosure solves the problem of waterproof and dustproof thereof, and by optimizing the shape of the push rod and additionally providing the buffer nut, reduces noise and further improves operational stability. The adopted structures and processes are convenient for industrial implementation, are applicable to an automatic door opening and closing system of an automobile, and have significant practical value.

1. An automatic door opening and closing actuator, comprising a mounting housing and a push rod, one end of the push rod extending out of a channel arranged in the mounting housing, and the other end of the push rod being arranged to slide reciprocally inside the mounting housing, wherein the automatic door opening and closing actuator further comprises a sealing tube sleeved outside the push rod, one end of the sealing tube is provided with a wrapping ring of an elastic material that wraps the push rod, and the other end of the sealing tube is hermetically fixed to an inner wall or one end of the channel; and
an inner wall of the wrapping ring is provided with a circumferentially arranged first protruding ring, two sides of the first protruding ring on the inner wall of the wrapping ring are each provided with at least one second protruding ring arranged at intervals, and an oil groove for storing lubricating grease is formed between any adjacent first protruding ring and second protruding ring or between any two adjacent second protruding rings, wherein
both the first protruding ring and the second protruding rings are in interference fit with the push rod, and an annular center line of the first protruding ring is collinear with a center line of the push rod at a contact position between the first protruding ring and the push rod.

2. The automatic door opening and closing actuator according to claim 1, wherein the push rod extends along a curve to form a special-shaped rod structure.

3. The automatic door opening and closing actuator according to claim 2, wherein a cross-section of the push rod along a length direction of the push rod is circular.

4. The automatic door opening and closing actuator according to claim 2, wherein a cross-section of the push rod along a length direction of the push rod comprises any one of a rectangle, a lantern shape, and an isosceles trapezoid.

5. The automatic door opening and closing actuator according to claim 1, wherein two second protruding rings exist, the two second protruding rings are respectively arranged on the two sides of the first protruding ring, and inner walls of the two second protruding rings are inclined relatively outward along the first protruding ring.

6. The automatic door opening and closing actuator according to claim 2, wherein the sealing tube comprises a built-in supporting framework and an outer wrapping elastic layer, and the wrapping ring is connected to the elastic layer to form an integrated structure.

7. The automatic door opening and closing actuator according to claim 6, wherein the supporting framework is of a through-cavity structure; the wrapping ring is arranged at one end of the supporting framework, and another end of the supporting framework is provided with an annular plate extending vertically outward; a positioning plate extending and fixed in parallel is fixed on the annular plate, and the positioning plate is provided with a mounting through hole that is consistent with a direction of a through-cavity of the supporting framework; and the elastic layer is arranged to wrap the supporting framework, the annular plate, and the positioning plate.

8. The automatic door opening and closing actuator according to claim 7, wherein the elastic layer wraps two sides of the annular plate and the positioning plate, and the elastic layer wrapping outside the annular plate and the positioning plate is provided with two annular sealing rings extending outward respectively on the two sides of the annular plate and the positioning plate.

9. The automatic door opening and closing actuator according to claim 6, wherein a plurality of connecting recesses are uniformly arranged on an outer wall of the supporting framework, and the elastic layer covers the plurality of connecting recesses and is attached and fixed to the supporting framework.

10. The automatic door opening and closing actuator according to claim 1, wherein the automatic door opening and closing actuator further comprises a drive assembly, a lead screw and a nut slider; the drive assembly is arranged inside the mounting housing, and is configured to drive the lead screw to rotate; the lead screw is rotatably arranged inside the mounting housing, and the nut slider is sleeved on the lead screw and threadedly connected to the lead screw; and one end of the push rod located inside the mounting housing is hinged to the nut slider.

11. The automatic door opening and closing actuator according to claim 10, wherein a threaded through hole is arranged in the nut slider, and the lead screw is sleeved in the threaded through hole and in threaded transmission with the threaded through hole; a buffer nut of an elastic material is fixed on the nut slider, an inner ring of the buffer nut is provided with a spiral line in a same direction as the threaded through hole, and the buffer nut is sleeved outside the lead screw and threadedly connected to the lead screw in interference fit; and a center line of the buffer nut, a center line of the lead screw, and a center line of the threaded through hole are collinearly arranged.

12. The automatic door opening and closing actuator according to claim 11, wherein the nut slider comprises a built-in metal framework that is wrapped and fixed and an external plastic layer; a mounting through hole is arranged in the metal framework, a plastic nut is fixed in the mounting through hole, and an inner hole of the plastic nut is the threaded through hole.

13. The automatic door opening and closing actuator according to claim 12, wherein a mounting groove is arranged on the metal framework, a connecting end of the push rod is located in the mounting groove and hinged to the mounting groove through a pin screw, and a center line of the pin screw is perpendicular to the center line of the threaded through hole; and
a length direction of the push rod is parallel to a length direction of the lead screw, and the push rod rotates along the pin screw while moving with a rotation of the lead screw.

14. The automatic door opening and closing actuator according to claim 13, wherein a connecting hole communicated with the mounting groove is arranged in the nut slider, one end of the pin screw is fixed to a side wall of the mounting groove, and another end of the pin screw is located in the mounting groove or the connecting hole.

15. The automatic door opening and closing actuator according to claim 12, wherein an outer wall of the plastic layer is in sliding contact with an inner wall of the mounting housing; and the plastic layer is provided with a chamfered surface adapted to a bolt hole outside the mounting housing, and the chamfered surface is provided with an arc-shaped recessed area with a center of a circle facing outward.

16. The automatic door opening and closing actuator according to claim 11, wherein a mounting groove protruding outward along the threaded through hole is arranged on the nut slider, and the buffer nut is embedded and fixed in the mounting groove.

17. The automatic door opening and closing actuator according to claim 11, wherein the nut slider is provided with two inwardly recessed sliding grooves and an outwardly protruding auxiliary slider, and a length direction of the sliding grooves is arranged along a length direction of the lead screw.

18. The automatic door opening and closing actuator according to claim 2, wherein two second protruding rings exist, the two second protruding rings are respectively arranged on the two sides of the first protruding ring, and inner walls of the two second protruding rings are inclined relatively outward along the first protruding ring.

19. The automatic door opening and closing actuator according to claim 3, wherein two second protruding rings exist, the two second protruding rings are respectively arranged on the two sides of the first protruding ring, and inner walls of the two second protruding rings are inclined relatively outward along the first protruding ring.

20. The automatic door opening and closing actuator according to claim 4, wherein two second protruding rings exist, the two second protruding rings are respectively arranged on the two sides of the first protruding ring, and inner walls of the two second protruding rings are inclined relatively outward along the first protruding ring.
